(19) United States
(12) Patent Application Publication
(10) Pub. No.: US 2010/0141467 A1
(43) Pub. Date: Jun. 10, 2010

(54) Apparatus for Providing Visual and/or Audible Alert Signals

(76) Inventor: Gary John Kirkpatrick, New South Wales (AU)

Correspondence Address: DORITY & MANNING, P.A., POST OFFICE BOX 1449, GREENVILLE, SC, 29602-1449, US

(21) Appl. No.: 12/526,204

(22) PCT Filed: Feb. 6, 2008
(86) PCT No.: PCT/AU08/00142

§ 371 Date: Feb. 23, 2010

(30) Foreign Application Priority Data
Feb. 7, 2007 (AU) 2007900588

(51) Int. Cl. G09F 9/33; G08B 7/04; H04R 27/00

(52) U.S. Cl. 340/815.45; 340/815.72; 381/82

(57) ABSTRACT

Apparatus (100, 300, 400) for providing visual and/or audible alert signals. The apparatus (100, 300, 400) comprises one or more lighting means (e.g., 105) for providing visual signals and siren means (e.g., 104) for generating at least one selected siren tone. The apparatus (100, 300, 400) also comprise speaker means (e.g., 103) for producing the audible alert signal based on the selected siren tone and magnetic attaching means (108) for attaching the apparatus (100, 300, 400) to the exterior of a vehicle housing magnetic attraction, wherein at least a portion of the magnetic attaching means (108) is configured to be de-energised in order to detach the apparatus (100, 300, 400) from the exterior of the vehicle.

### FIELD OF THE INVENTION

The present invention relates generally to light bars and, in particular, to an apparatus for providing visual and/or audible alert signals.

### BACKGROUND

Beacons and light bars are devices designed to enable the easy identification of an official vehicle. Most emergency vehicles and utility vehicles are fitted with one or more beacons or light bars for use in providing a visual alert to other vehicles and pedestrians of emergency situations or other road hazards. Such vehicles are also often fitted with a siren or other audible device for providing an audible alert. Such sirens are typically fitted at the front of the vehicle (e.g., behind the grill).

A single beacon may be used by emergency services because of their low cost and low air resistance. Multiple beacons of different colours are also used on some vehicles. Single beacons may also be used with light bars, as secondary lights either mounted on the top of the vehicle or inside the vehicle. For example, a vehicle fitted with a light bar on the top of the vehicle may also comprise a single beacon inside the vehicle facing out the windshield or rear window. Beacons are also commonly used on utility and construction vehicles when a light bar is not able to be attached to the vehicle.

Conventional beacons comprise one or more light bulbs around which a curved mirror is spun, creating a rotating beam of light. However, in recent times, the light bulbs have been replaced with an omni-directional strobe light, a flashing halogen bulb or light emitting diodes (LEDs). LED-based beacons and light bars are increasingly popular among many emergency agencies for several reasons. Solid-state LEDs are very efficient and draw less current than halogen/incandescent rotating lights and strobe lights. LEDs also have fast on/off transition times and no moving parts. Finally, LED light bars can be made very thin to offer less wind resistance.

In any event, most single beacons comprise a dome typically made of coloured plastic, which covers the light bulbs or other forms of lights for protecting the lights. These coloured domes are typically of a single solid color. Although, in some instances, left and right halves of the dome are of a different color. The relationship between the color of the beacon and the service in which the beacon is being used varies according to jurisdiction and legislation. For example, in North America and Asia, emergency services use red and blue beacons. In Western Europe and Australia, emergency services typically use blue beacons. Amber beacons are also used in many jurisdictions as a warning color for other services and industries, such as rangers, construction vehicles etc.

Lightbars may comprise halogen/incandescent rotating lights (with or without accompanying mirrors), strobe lights, LED panels, two-tiered lights, fixed-beam “takedown” flashing lights, side-facing “alley” spotlights and directional traffic advisory arrows.

Some conventional single beacons comprise a magnetic mount for use in situations where permanent mounting is not appropriate. For example, services such as detectives, covert police, volunteer fire fighters, or rangers, may use a magnetic mount beacon which is placed on the roof of a vehicle temporarily to alert other vehicles and pedestrians of emergency situations or other road hazards. As discussed above, the vehicle often also comprises sirens or other audible warning devices installed in the vehicle. This arrangement has the disadvantage that the range of vehicles able to be used with magnetic mount beacons is limited by whether or not the vehicle has a siren or other audible device installed in the vehicle. If the vehicle does not comprise a siren or other audible device then the driver is forced to blow the horn of the vehicle continuously to audibly alert other vehicles and pedestrians.

Another disadvantage of conventional magnetic mount beacons is that they are often mishandled and damaged when not in use. For example, an emergency service officer may remove the beacon from the roof of a vehicle and throw the beacon in the vehicle in which case the plastic dome if often damaged. A still further disadvantage of conventional magnetic mount beacons is that they are notoriously difficult to detach from the roof of a vehicle. In order to detach the beacon from the roof, the beacon needs to be “slid” off the roof. This action often results in the roof of the vehicle being scratched and damaged.

Thus, a need clearly exists for an improved apparatus for providing visual and/or audible alert signals which is portable and able to be used on any vehicle.

### SUMMARY

It is an object of the present invention to substantially overcome, or at least ameliorate, one or more disadvantages of existing arrangements.

Apparatus for providing visual and/or audible alert signals, said apparatus comprising:

one or more lighting means for providing visual signals;

siren means for generating at least one selected siren tone;

speaker means for producing said audible alert signal based on said selected siren tone; and

magnetic attaching means for attaching said apparatus to the exterior of a vehicle using magnetic attraction, wherein at least a portion of the magnetic attaching means is configured to be de-energised in order to detach said apparatus from the exterior of the vehicle.

According to another aspect of the present invention there is provided apparatus for providing visual and/or audible alert signals, said apparatus comprising:

cover means being one of one or more predetermined colours;

one or more lighting means configured within said cover means, for providing flashing visual signals;

siren means attached to said cover means for generating at least one selected siren tone;

speaker means for producing said audible alert signal based on said selected siren tone; and

magnetic attaching means attached to said cover means for attaching the apparatus to the exterior of a vehicle, wherein at least a portion of the magnetic attaching means is configured to be de-energised in order to detach the apparatus from the exterior of the vehicle.

Other aspects of the invention are also disclosed.

### BRIEF DESCRIPTION OF THE DRAWINGS

One or more embodiments of the present invention will now be described with reference to the drawings and appendices, in which:

FIG. 1 shows a single beacon in accordance with one embodiment;

FIG. 2A shows a switch box for use with the beacon of FIG. 1;

FIG. 2B shows a side profile for the switch box of FIG. 2A;

FIG. 3 shows a light bar in accordance one embodiment; and

FIG. 4 shows a single beacon in accordance with another embodiment.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or patent applicant that such documents or devices in any way form part of the common general knowledge in the art.

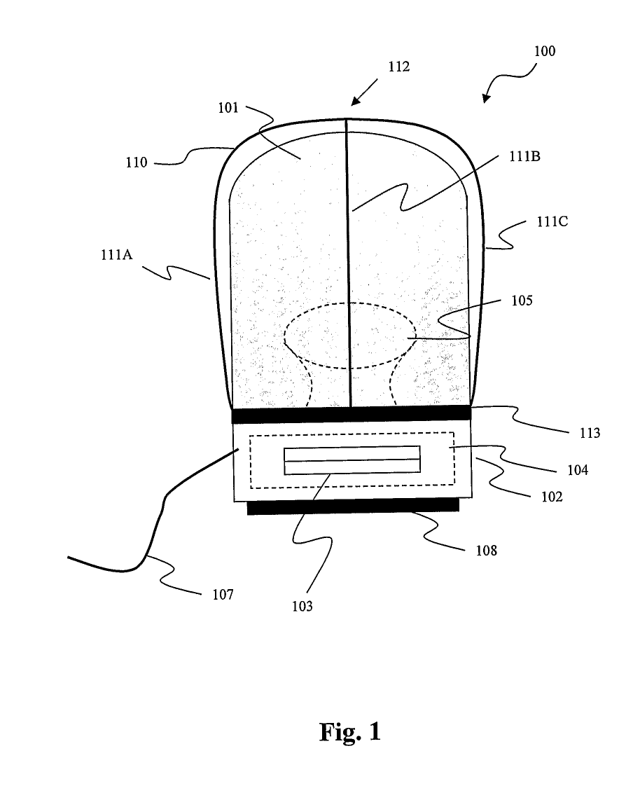

FIG. 1 shows an apparatus for providing visual and/or audible alert signals in the form of a beacon 100 in accordance with one embodiment. As will be described below, the beacon 100 provides a degree of portability and convenience that are not provided by conventional light bars. The beacon 100 is a portable device which may be placed on the roof of a vehicle temporarily to alert other vehicles and pedestrians of emergency situations or other road hazards. The beacon 100 is particularly suitable for services such as detectives, covert police, volunteer fire fighters, or rangers.

The beacon 100 comprises a dome 101. The dome 101 is blue. However, the dome 101 may be any colour depending on the service in which the beacon 100 is being used. For example, the dome 101 may be any colour including blue, red, orange or any combination thereof. In one embodiment, the dome 101 may be half blue and half red.

The dome 101 is mounted on a frame 102. The frame 102 may be made of any suitable material such as metal or plastic.

A lighting means, for providing visual signals, in the form of an omni-directional strobe light 105 is mounted on the frame 102 within the dome 101 for use as a light source. Alternatively, the lighting means may be a flashing halogen bulb or LEDs.

A siren means in the form of an electronic siren 104 is mounted within the frame 102, as represented by phantom lines. The electronic siren 104 is connected directly to a speaker means in the form of a siren speaker 103 which protrudes through the frame. The electronic siren 104 incorporates circuits such as oscillators, modulators, and amplifiers for generating (or synthesizing) a selected siren tone (e.g., wail, yelp, pierce/priority/phaser, hi-lo, scan) which is played through the speaker 103. The electronic siren 104 is preferably also configured to provide an “air horn” tone upon selection. Further, the electronic siren 104 is preferably also configured to be useable as a public address (PA) system. The speaker 103 is configured to produce an audible alert signal based on the selected siren tone.

The frame 102 also comprises a magnetic attaching means in the form of a magnet 108 attached to the base of the frame 102. The magnet 108 may be used for attaching the beacon 100 to the exterior (i.e., typically the roof) of a vehicle using magnetic attraction. Accordingly, the light 105 and siren 104 are configured within an exterior of the beacon 100. The magnet 108 allows the beacon 100 to be placed on the roof of a vehicle temporarily to alert other vehicles and pedestrians of emergency situations or other road hazards.

The beacon 100 also comprises a cable 107 connected to the frame for providing power and control signals to the strobe light 105 and electronic siren 104. In use, one end of the cable 107 is connected to a power supply (e.g., the cigarette lighter of a vehicle) to provide any suitable voltage (e.g., twelve (12) volts, twenty four (24) volts) to the electronic siren 104 and strobe light 105.

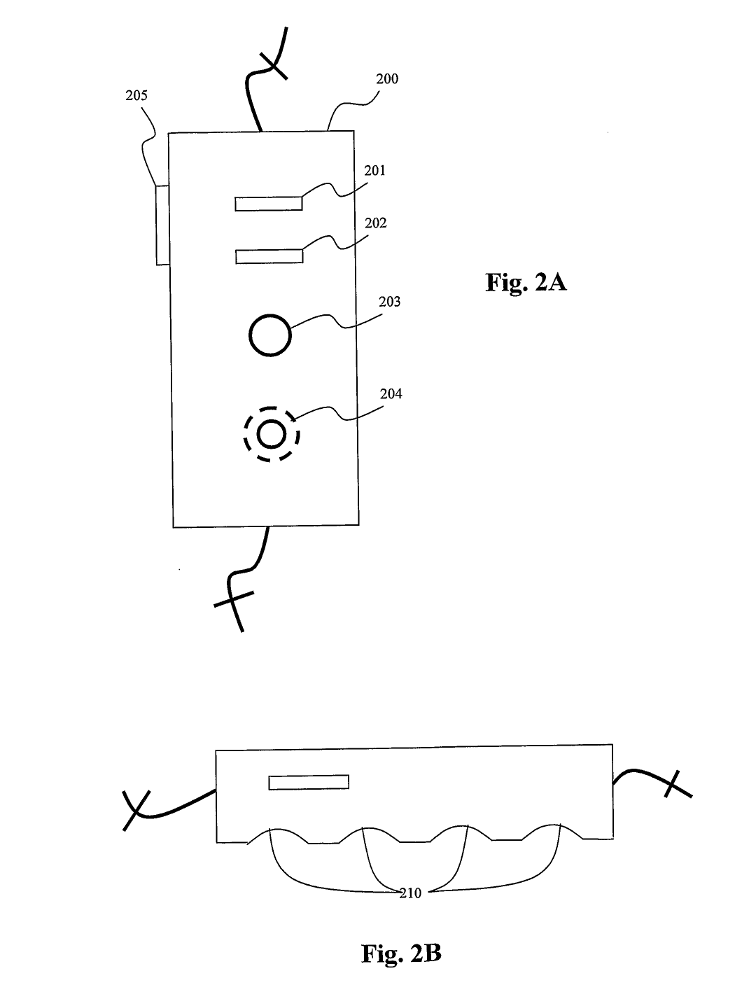

A switch box 200, as seen in FIGS. 2A and 2B, is connected in series between the power supply and the beacon 100. The switch box 200 may be located at any convenient position on the cable 107. The switch box 200 comprises a switch 201 for the light 105 and a switch 202 for the electronic siren 104. The switch box 200 also comprises an air horn selector button 203, which when selected causes the electronic siren 104 to produce an air horn tone.

The switch box 200 also comprises a microphone 204 and push-to-talk button 205. When selected the push-to-talk button 205 preferably overrides any siren signal being generated by the electronic siren 104 so that the siren 104 is configured for instant public address (PA) use. In some embodiments, the public address volume may be adjustable by means of a gain control button (not shown) configured on the switch box 200.

FIG. 2B shows a side profile of the switch box 200. The switch box 200 preferably comprises one or more scallops 210 on the base of the switch box 200 for receiving the fingers of the driver/passenger holding the switch box 200.

As shown in FIG. 1, the beacon 100 preferably comprises a protective frame means in the form of a protective frame 110 substantially surrounding the dome 101 for protecting the dome 101 from damage in the event that the beacon 100 is dropped or thrown against a hard surface, for example. The protective frame 110 may be formed from any suitable material such as steel wire, rubber or a flexible plastic. As shown in FIG. 1, the protective frame 110 has four strands 111A, 111B, 111C and 111D (not shown) which are each fixed at one end to a ring 113 which is fitted to surround the frame 102 and/or dome and secure the protective frame 110 to the beacon 100. At another end, each of the four strands 111A, 111B, 111C and 111D are joined at a point 112.

In one embodiment, the frame 102 may also be covered by a sheath made of any suitable material including rubber or plastic, for protecting the frame from damage.

Accordingly, in use (e.g., in an emergency situation), the beacon 100 is placed on the roof of a vehicle with the cable 107 running back to the interior of the vehicle through a window of the vehicle where the cable 107 is connected via a plug (not shown) to the power supply (e.g., cigarette lighter) located inside the vehicle. The driver or a passenger of the vehicle may then select the button 201 to operate the strobe light 105 to provide a visual alert signal to other vehicles and pedestrians of emergency situations or other road hazards. The driver/passenger may also select the button 203 to operate the siren 104 to cause the siren 104 to generate a siren tone. The speaker 103 then produces the audible alert signal based on the generated siren tone. In this instance, the driver/passenger may select the push-to-talk button 205, which as described above, overrides any siren signal being generated by the electronic siren 104. The driver/passenger may then speak into the microphone 204 to address anybody outside the vehicle.

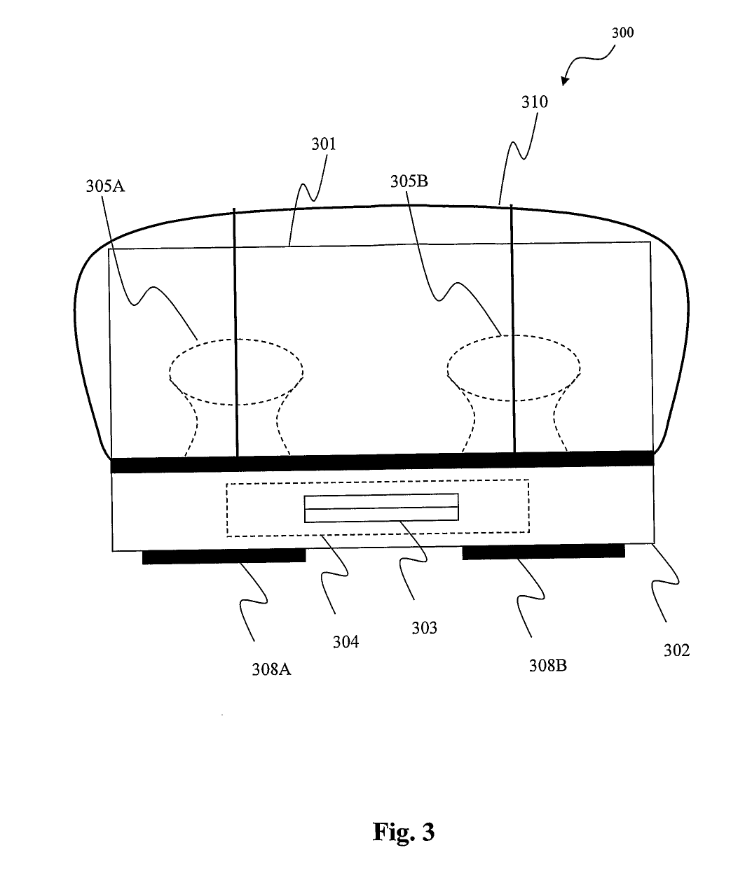

FIG. 3 shows another apparatus in the form of a light bar 300 in accordance with another embodiment, which works in a similar manner to the beacon 100. Again, the light bar 300 may be placed on the roof of a vehicle temporarily to alert other vehicles and pedestrians of emergency situations or other road hazards. The light bar 300 is particularly suitable for services such as detectives, covert police, volunteer fire fighters, or rangers.

The light bar 300 comprises a cover 301. The cover 301 is blue. However, the cover 301 may be any colour depending on the service in which the light bar 300 is being used. For example, the cover 301 may be any colour including blue, red, orange or any combination thereof. In one embodiment, the cover 301 may be half blue and half red.

The cover 301 is mounted on a frame 302. Again, the frame 302 may be made of any suitable material such as metal or plastic.

The light bar 300 comprises lighting means, for providing visual signals, in the form of an omni-directional strobe light 305A mounted on one side of the frame 302 and another omni-directional strobe light 305B mounted on another side of the frame 302, within the cover 301. Alternatively, the strobe lights 305A and 305B may be replaced by flashing halogen bulbs or LEDs.

Again, a siren means in the form of an electronic siren 304, similar to the electronic siren 104 described above, is mounted within the frame 302, as represented by phantom lines. Again, the electronic siren 304 is connected directly to a siren speaker 303 which protrudes through the frame 302. The electronic siren 304 also incorporates circuits such as oscillators, modulators, and amplifiers for generating a selected siren tone (e.g., wail, yelp, pierce/priority/phaser, hi-lo, scan) which is played through the speaker 303. The electronic siren 304 is preferably also configured to provide an “air horn” tone upon selection. Further, the electronic siren 304 is preferably also configured to be useable as a public address (PA) system as described above. The speaker 303 is configured to produce an audible alert signal based on the selected siren tone

The frame 302 also comprises magnetic attaching means in the form of magnets 308A and 308B attached to the base of the frame 302. Again, the magnets 308A and 308B may be used for attaching the light bar 300 to the exterior (i.e., typically the roof) of a vehicle using magnetic attraction. Accordingly, the lights 305 and siren 304 are configured within an exterior of the light bar 300.

Similar to the beacon 100, the light bar 300 also comprises a cable 307 connected to the frame 302 for providing power and control signals to the strobe lights 305A and 305 B and electronic siren 304.

As shown in FIG. 3, the light bar 300 also preferably comprises a protective frame means in the form of a protective frame 310, similar to the protective frame 110, surrounding the cover 301, in order to protect the cover 301 from damage in the event that the light bar 300 is dropped or thrown against a hard surface, for example. The frame 302 may also be covered by a sheath made of any suitable material including rubber or plastic, for protecting the frame 302 from damage.

Accordingly, the beacon 100 and light bar 300 described above provides a degree of portability and convenience that are not provided by conventional light bars. The magnets 108, 308A and 308B allow the light bars 100 and 300 to be placed on the roof of a vehicle temporarily to alert other vehicles and pedestrians of emergency situations or other road hazards. The beacon 100 and light bar 300 may be used in any vehicle. The vehicle does not have to comprise a siren or other audible device. There is therefore no need for the driver to blow the horn of the vehicle, or the like, to audibly alert other vehicles and pedestrians.

Another advantage of the beacon 100 and light bar 300 described above is that the protective frames 110 and 310, respectively, protect the beacon 100 and light bar 300 from damage in the event of mishandling.

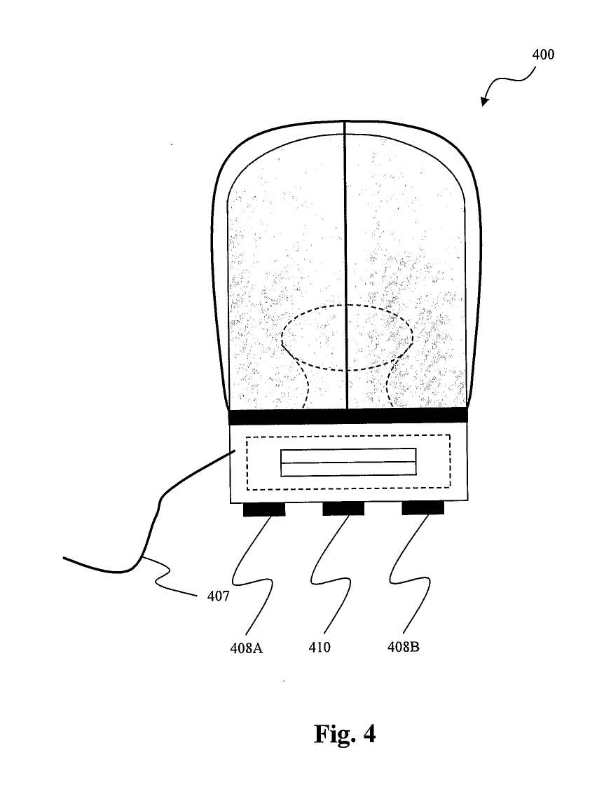

In the embodiments described above, the magnetic attaching means, in the form of the magnet 108 or the magnets 308A and 308B, is formed from “hard” or “permanent” magnets. In an alternative embodiment, the magnetic attaching means may be formed by electromagnets or a combination of permanent and electromagnets. For example, FIG. 4 shows an apparatus for providing visual and/or audible alert signals in the form of a beacon 400 in accordance with one embodiment. The beacon 400 is similar to the beacon 100. However, as seen in FIG. 4, the beacon 400 comprises magnetic attaching means in the form of three magnets 408A, 408B and 410. The magnets 408A and 408B are permanent magnets and the magnet 410 is an electromagnet. For the beacon 400, at least a portion of the magnetic attaching means is configured to be de-energised in order to detach the beacon 400 from the exterior of the vehicle.

Preferably, the magnets 408A and 408B produce a fairly small magnetic field. However, when energised the electromagnet 410 preferably produces a strong magnetic field. The electromagnet 410 is preferably powered via a cable 407, which is the same as the cable 107, connected to a power supply such as the cigarette lighter of a vehicle. In this instance, when the cable 407 is plugged into the cigarette lighter, the electromagnet 410 is energised. Conversely, when the cable 407 is disconnected from the cigarette lighter, the electromagnet 410 is de-energised. Alternatively, a switch box, similar to the switch box 200, connected in series between the power supply and the beacon 100 may comprise a switch (not shown) for energising and de-energising the electromagnet 410. In a still further alternative, the electromagnet 410 may be energised and de-energised via a switch located on the beacon 400.

Accordingly, in use the beacon 400 is placed on the roof of a vehicle with the cable 407 running back to the interior of the vehicle through a window of the vehicle. Before connecting the cable 407 to the power supply, such as the cigarette lighter, the electromagnet 410 is de-energised. In this state, the magnets 408A and 408B provide a small magnetic field to merely hold the beacon 400 in place on the roof. As such, the beacon 400 may be easily removed from the roof of the vehicle by lifting the beacon 400. The arrangement of the magnets 408A and 408B and the electromagnet 410, allows the light beacon 400 to be placed on the roof of a vehicle temporarily to alert other vehicles and pedestrians of emergency situations or other road hazards. The arrangement of the magnets 408A and 408B and the electromagnet 410, also allows the light beacon 400 to be easily removed from the roof of the vehicle without damaging the vehicle.

However, once the cable 407 is connected via a plug to the power supply the electromagnet 410 is energised to provide a strong magnetic field fixing the beacon 400 more strongly to the roof of the vehicle. The magnetic field provided by the electromagnet 410 is preferably large enough so that the electromagnet 410 needs to be de-energised in order to detach the beacon 400 from the roof of the vehicle. Accordingly, once the electromagnet 410 is de-energised, by unplugging the cable 407 from the power supply, the beacon 400 is easily detached from the roof by lifting the beacon 400.

The beacon 400 according to the embodiment of FIG. 4 overcomes the disadvantage of conventional magnetic mount beacons of being difficult to detach from the roof of a vehicle. The beacon 400 may be easily detached from the roof merely by de-energising the electromagnet 410 thus saving the roof from being scratched or damaged.

The foregoing describes only some embodiments of the present invention, and modifications and/or changes can be made thereto without departing from the scope and spirit of the invention, the embodiments being illustrative and not restrictive. For example, as described above, the electronic sirens 104 and 304 are located within the frames 102 and 302, respectively. Alternatively, the electronic sirens 104 and 304 may be positioned in the vehicles with the speakers 103 and 303 being mounted within the frames 102 and 302, respectively. As an example, for the beacon 100, the speaker 103 may be located within the frame 102 and may communicate, via the cable 102, with the siren 104 located in the vehicle. In this instance, rather than the switches 202 and 203 being located on the switch box 200, the switches 202 and 203 may be located on the siren 104. The switch 202 located on the siren 104 may be selected to generate a selected siren tone which is then communicated, via the cable 102, to the speaker 103 located in the frame 102.

In a still further embodiment, the apparatus 100, 300 and 400 according to anyone of the embodiments described above may comprise an internal power supply, for example, in the form of a battery or battery pack.

In a still further embodiment, the apparatus 100 or the apparatus 300 may also comprise a radio receiver, an infrared receiver or similar device. In this instance, the apparatus 100, 300 or 400 may be controlled wirelessly via a remote control unit (e.g., a radio transmitter), rather than via the switch box on the cable 107. Such embodiments may not require the cable 107 at all. The remote control unit may comprise the switch 201 for controlling the light 105, the switch 202 for controlling the electronic siren 104, the air horn selector button 203, the microphone 204 and the push-to-talk button 205. In this instance, selection of anyone of the buttons on the remote control will result in a wireless signal being sent to the apparatus 100, 300 or 400 in order for the corresponding function to be performed. For example, when the push-to-talk button 205 is selected on the remote control a wireless signal is sent to the apparatus 100, 300 or 400 so that the siren 104 is configured for instant public address (PA) use. The driver/passenger holding the remote control unit may then speak into the microphone 204 of the remote control unit which wirelessly communicates with the apparatus 100, 300 or 400 to allow the driver/passenger to address anybody outside the vehicle. Further, for such an embodiment, the magnetic means may be energised and de-energised via a switch located on the apparatus.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. Apparatus for providing visual and/or audible alert signals, said apparatus comprising:
one or more lighting means for providing visual signals;
siren means for generating at least one selected siren tone;
speaker means for producing said audible alert signal based on said selected siren tone; and
magnetic attaching means for attaching said apparatus to the exterior of a vehicle using magnetic attraction, wherein at least a portion of the magnetic attaching means is configured to be de-energised in order to detach said apparatus from the exterior of the vehicle.

2. Apparatus according to claim 1, wherein said lighting means and said siren means are configured within said apparatus.

3. Apparatus according to claim 1, further comprising a protective frame means substantially surrounding said apparatus for protecting said apparatus from damage.

4. Apparatus according to claim 1, wherein said lighting means is formed by one or more strobe lights.

5. Apparatus according to claim 1, wherein said lighting means is formed by light emitting diodes.

6. Apparatus according to claim 1, wherein said lighting means is formed by one or more flashing halogen bulbs.

7. Apparatus according to claim 1, wherein said apparatus is connected to a power supply within the vehicle via a cable.

8. Apparatus according to claim 7, wherein said magnetic attaching means is de-energised by disconnecting the cable from the power supply.

9. Apparatus according to claim 7, wherein said magnetic attaching means is de-energised via a switch.

10. Apparatus according to claim 1, wherein said apparatus comprises an internal power supply.

11. Apparatus according to claim 1, wherein at least a portion of the exterior of said apparatus is of one or more predetermined colors such that said visual signals project said colors.

12. Apparatus according to claim 1, wherein said siren means is configured to produce an air horn tone.

13. Apparatus according claim 1, wherein said speaker means is configured for use as a public address system.

14. Apparatus for providing visual and/or audible alert signals, said apparatus comprising:
cover means being one of one or more predetermined colors;
one or more lighting means configured within said cover means, for providing flashing visual signals;
siren means attached to said cover means for generating at least one selected siren tone;
speaker means for producing said audible alert signal based on said selected siren tone; and
magnetic attaching means attached to said cover means for attaching the apparatus to the exterior of a vehicle, wherein at least a portion of the magnetic attaching means is configured to be de-energised in order to detach the apparatus from the exterior of the vehicle.

15. Apparatus according to claim 14, wherein said lighting means and said siren means are configured within said apparatus.

16. Apparatus according to claim 14, further comprising a protective frame means substantially surrounding said apparatus for protecting said apparatus from damage.

17. Apparatus according to claim 14, wherein said lighting means is formed by one or more strobe lights.

18. Apparatus according to claim 14, wherein said lighting means is formed by light emitting diodes.

19. Apparatus according to claim 14, wherein said lighting means is formed by one or more flashing halogen bulbs.

20. Apparatus according to claim 14, wherein said apparatus is connected to a power supply within the vehicle via a cable.

21. Apparatus according to claim 20, wherein said magnetic attaching means is de-energised by disconnecting the cable from the power supply.

22. Apparatus according to claim 20, wherein said magnetic attaching means is de-energised via a switch.

23. Apparatus according to claim 14, wherein said apparatus comprises an internal power supply.

24. Apparatus according to claim 14, wherein at least a portion of the exterior of said apparatus is of one or more predetermined colors such that said visual signals project said colors.

25. Apparatus according to claim 14, wherein said siren means is configured to produce an air horn tone.

26. Apparatus according to claim 14, wherein said speaker means is configured for use as a public address system.

27. Apparatus according to claim 1, wherein said apparatus is controlled wirelessly.

28. Apparatus according to claim 1, further comprising one or more permanent magnetic attaching means for attaching said apparatus to the exterior of the vehicle.
